(19) United States
(12) Patent Application Publication
(10) Pub. No.: US 2012/0219815 A1
(43) Pub. Date: Aug. 30, 2012

(54) LIGNOCELLULOSE MATERIALS HAVING GOOD MECHANICAL PROPERTIES

(75) Inventors: Michael Schmidt, Dudenhofen (DE); Michael Finkenauer, Westhofen (DE); Günter Scherr, Ludwigshafen (DE); Frank Braun, Ludwigshafen (DE); Stephan Weinkötz, Neustadt (DE); Maxim Peretolchin, Mannheim (DE); Jürgen von Auenmüller, Oberhausen-Rheinhausen (DE)

(73) Assignee: BASF SE, Ludwigshafen (DE)

(21) Appl. No.: 13/508,237

(22) PCT Filed: Nov. 2, 2010
(86) PCT No.: PCT/EP10/66586

§ 371 Date: May 4, 2012

Related U.S. Application Data
(60) Provisional application No. 61/258,614, filed on Nov. 6, 2009.

(51) Int. Cl. B32B 21/08; B32B 37/18; C08L 97/02

(52) U.S. Cl. 428/528; 524/14; 156/306.6

(57) ABSTRACT

A process for the production of a lignocellulose-containing substance having an average density in the range from more than 600 to 900 kg/m³, in which, in each case based on the lignocellulose-containing substance:
A) from 30 to 95% by weight of lignocellulose particles;
B) from 1 to 25% by weight of expanded plastics particles having a bulk density in the range from 10 to 100 kg/m³;
C) from 3 to 50% by weight of a binder selected from the group consisting of aminoplast resin, phenol-formaldehyde resin and organic isocyanate having at least two isocyanate groups and, if appropriate
D) additives,
   are mixed and then pressed at elevated temperature and under elevated pressure.

The present invention relates to a process for the production of a lignocellulose-containing substance having an average density in the range from more than 600 to 900 kg/m³, in which, in each case based on the lignocellulose-containing substance:
A) from 30 to 95% by weight of lignocellulose particles;
B) from 1 to 25% by weight of expanded plastics particles having a bulk density in the range from 10 to 100 kg/m³;
C) from 3 to 50% by weight of a binder selected from the group consisting of aminoplast resin, phenol-formaldehyde resin and organic isocyanate having at least two isocyanate groups and, if appropriate
D) additives
   are mixed and then pressed at elevated temperature and under elevated pressure.

The sum of the components A), B), C) and, if appropriate, D) is 100%.

Furthermore, the present invention relates to a process for the production of a multilayer lignocellulose material, the lignocellulose-containing substance, a multilayer lignocellulose material and the use of a lignocellulose-containing substance or of a multilayer lignocellulose material, in each case as defined in the claims.

Lignocellulose materials, for example wood-base materials, in particular multilayer wood-base materials, are an economical and resource-protecting alternative to solid wood and have become very important in particular in furniture construction, in laminate floors and as construction materials. Wood particles of different thickness, for example woodchips or wood fibers of various timbers, usually serve as starting materials. Such wood particles are usually pressed with natural and/or synthetic binders and, if appropriate, with addition of further additives to give board- or strand-like wood-base materials.

Such lignocellulose materials, for example wood-base materials, usually have a density of about 650 kg/m³ or more. Such lignocellulose materials generally have unsatisfactory transverse tensile strengths or swelling values or water absorptions and are therefore only used for less demanding standard applications.

For many applications, for example in the field of bathroom furniture or in construction for example in humid climates or for rooms with high air humidity, for example bathrooms, lignocellulose materials having improved mechanical properties, for example improved transverse tensile strength and lower water absorption or swelling values are sought.

The prior art comprises proposals for modifying wood-base materials by additions of filler polymers to the glue or to the wood particles.

CH 370229 describes light and simultaneously pressure-resistant compression moldings which consist of woodchips or wood fibers, a binder and a porous plastic serving as a filler. For the production of the compression moldings, the woodchips or wood fibers are mixed with binder and foamable or partly foamable plastics and the mixture obtained is pressed at elevated temperature. The compression moldings obtained have a low density (under 600 kg/m³).

WO 02/38676 describes a process for the production of filled lignocellulose products, in which from 5 to 40% by weight of foamable or already foamed polystyrene having a particle size of less than 1 mm, from 60 to 95% by weight of lignocellulose-containing material and binder are mixed and are pressed at elevated temperature and elevated pressure to give the finished product. In this case, the polystyrene is converted into a melt and is absorbed into the wood fibers (page 4, paragraph 2). The product described in the example therefore has a relatively high density of 1.2 g/cm³ (1200 kg/m³).

WO 2008/046890A (BASF SE), WO 2008/046891 A (BASF SE) and WO 2008/046892 A (BASF SE) describe, inter alia, light wood-containing substances which comprise, for example, woodchips or wood fibers, a binder and a porous plastic serving as a filler. For the production of the wood-containing substances, for example, the woodchips or wood fibers are mixed with binder and foamable or partly foamable plastics and the mixture obtained is pressed at elevated temperature. WO 2008/046890 A, WO 2008/046891 A and WO 2008/046892 A describe densities of the wood-containing substances of 600 kg/m³ and less.

The object of the present invention was to provide lignocellulose-containing, preferably wood-containing, substances and lignocellulose materials, preferably wood-base materials having improved mechanical properties and low water absorption and swelling values but still good processing properties, such as conventional wood-base materials of equal density.

The mechanical strength can be determined by measuring the transverse tensile strength according to EN 319.

Furthermore, the swelling value (which can be determined according to EN 317) of the lignocellulose materials, preferably wood-base materials, should not be adversely affected.

The object was achieved by a process for the production of a lignocellulose-containing substance having an average density in the range from more than 600 to 900 kg/m³, in which, in each case based on the lignocellulose-containing substance:
A) from 30 to 95% by weight of lignocellulose particles;
B) from 1 to 25% by weight of expanded plastics particles having a bulk density in the range from 10 to 100 kg/m³;
C) from 3 to 50% by weight of a binder selected from the group consisting of aminoplast resin, phenol-formaldehyde resin, and organic isocyanate having at least two isocyanate groups and, if appropriate
D) additives
   are mixed and then pressed at elevated temperature and under elevated pressure.

The terms lignocellulose, lignocellulose particles or lignocellulose-containing substance are known to the person skilled in the art.

Here, lignocellulose-containing substance, lignocellulose-containing particles or lignocellulose particles are, for example, straw or wood parts, such as wood layers, wood strips, woodchips, wood fibers or wood dust, woodchips, wood fibers and wood dust being preferred. The lignocellulose-containing particles or lignocellulose particles may also originate from wood fiber-containing plants, such as flax, hemp.

Starting materials for wood parts or wood particles are usually timbers from the thinning of forests, industrial timbers and used timbers and wood fiber-containing plants.

The processing to give the desired lignocellulose-containing particles, for example wood particles, is effected by known methods, cf. for example M. Dunky, P. Niemt, Holzwerkstoffe and Leime, pages 91-156, Springer Verlag Heidelberg, 2002.

Preferred lignocellulose-containing particles are wood particles, particularly preferably woodchips and wood fibers, as are used for the production of MDF and HDF boards.

Suitable lignocellulose-containing particles are also flax or hemp particles, particularly preferably flax or hemp fibers, as can be used for the production of MDF and HDF boards.

The lignocellulose-containing, preferable wood-containing, substance may comprise the customary small amounts of water (in a customary small range of variation); this water is not taken into account in the stated weights in the present application.

The stated weight of the lignocellulose particles, preferably wood particles, is based on lignocellulose particles, preferably wood particles, dried in a customary manner known to the person skilled in the art.

The stated weight of the binder is based, with respect to the aminoplast component in the binder, on the solids content of the corresponding component (determined by evaporating the water at 120° C. within 2 h, according, for example, to Günter Zeppenfeld, Dirk Grunwald, Klebstoffe in der Holz- und Möbelindustrie, 2nd edition, DRW-Verlag, page 268) and, with respect to the isocyanate, in particular the PMDI, on the isocyanate component per se, i.e. for example without solvent or emulsifying medium.

The lignocellulose-containing, preferably wood-containing, substances according to the invention have an average density in the range from at least 600 to 900 kg/m³, preferably from 600 to 850 kg/m³, particularly preferably from 600 to 800 kg/m³.

The transverse tensile strength of the lignocellulose-containing, preferably wood-containing, substances according to the invention or preferably of the multilayer lignocellulose materials, particularly preferably multilayer wood-base materials, according to the invention is usually more than 10% higher, preferably more than 20% higher, particularly preferably more than 30% higher, than the transverse tensile strength of an analogous lignocellulose-containing substance composed of the same constituents, of the same density, of the same thickness and from the same production procedure, but without component B).

The transverse tensile strength is determined according to EN 319.

The swelling value of the lignocellulose-containing, preferably wood-containing, substances according to the invention or preferably of the multilayer lignocellulose materials, particularly preferably multilayer wood-base materials, according to the invention is usually more than 10% lower, preferably more than 20% lower, particularly preferably more than 30% lower, than the swelling value of an analogous lignocellulose-containing substance composed of the same constituents, of the same density, of the same thickness and from the same production procedure, but without component B).

The swelling values are determined according to EN 317.

The water absorption (value) of the lignocellulose-containing, preferably wood-containing, substances according to the invention or preferably of the multilayer lignocellulose materials, particularly preferably multilayer wood-base materials, according to the invention is usually more than 10% lower, preferably more than 20% lower, particularly more than 30% lower, than the water absorption (value) of an analogous lignocellulose-containing substance composed of the same constituents, of the same density, of the same thickness and from the same production procedure, but without component B).

The water absorption (values) are likewise determined according to EN 317.

Suitable multilayer lignocellulose materials, preferably multilayer wood-base materials, are all materials which are produced from wood veneers, preferably having an average density of the wood veneers from 0.4 to 0.85 g/cm³, for example veneer boards or plywood boards or laminated veneer lumber (LVL).

Suitable multilayer lignocellulose materials, preferably multilayer wood-base materials, are preferably all materials which are produced from lignocellulose chips, preferably woodchips, preferably having an average density of the woodchips of from 0.4 to 0.85 g/cm³, for example particle boards or OSB boards, and wood fiber materials, such as LDF, MDF and HDF boards. Particle boards and fiber boards, in particular particle boards, are preferred.

The average density of the lignocellulose particles, preferably of the wood particles, of component A) is as a rule from 0.4 to 0.85 g/cm³, preferably from 0.4 to 0.75 g/cm³, in particular from 0.4 to 0.6 g/cm³.

Any desired type of wood is suitable for producing the wood particles; for example, spruce, beech, pine, larch, linden, poplar, ash, chestnut and fir wood are very suitable, and spruce and/or beech wood, in particular spruce wood, are preferred.

The dimensions of the lignocellulose particles, preferably wood particles, are not critical and depend as usual on the lignocellulose material, preferably wood-base material, to be produced, for example the abovementioned wood-base materials, such as particle boards, MDF, HDF or OSB.

Component B) comprises expanded plastics particles, preferably expanded thermoplastic particles.

Such expanded plastics particles are usually obtained as follows: compact plastics particles which comprise an expandable medium (also referred to as “blowing agent”) are expanded by the action of heat energy or pressure change (often also referred to as “foamed”). Here, the blowing agent expands, the particles increase in size and cell structures result.

This expansion is carried out in general in customary foaming apparatuses, often referred to as “preexpanders”. Such preexpanders can be installed in a stationary manner or may be mobile.

The expansion can be carried out in one stage or a plurality of stages. As a rule, in the one-stage process, the expandable plastics particles are expanded directly to the desired final size.

As a rule, in the multistage process, the expandable plastics particles are first expanded to an intermediate size and then expanded in one or more further stages by a corresponding number of intermediate sizes to the desired final size.

The abovementioned compact plastic particles, also referred to herein as “expandable plastics particles”, comprise as a rule no cell structures, in contrast to the expanded plastics particles.

These expanded plastics particles have only a low content of blowing agent, if any at all.

The expanded plastics particles thus obtained can be stored temporarily or further used without further intermediate steps for the production of the lignocellulose-containing substance.

Customary measures for ensuring production, such as feeding the expanded plastics particles into so-called buffer containers, which, for example, compensate for variations in the metering of the expanded plastics particles, or temporary storage for blowing agent reduction of the expanded plastics particles and the mixing of the component B) with other additives, for example components A), C) or, if appropriate, D), are not intermediate steps in the context of this invention.

Customary measures for blowing agent reduction of expanded plastics particles are, for example, relatively long storage, in general for from 12 hours to several days, of the expanded plastics particles in open vessels or in vessels having walls permeable to the blowing agent. This storage generally takes place at ambient temperature, for example from 20 to 30° C.

Here, “blowing agent reduction” is the reduction in the blowing agent concentration, detectable by customary analytical methods (for example gas chromatography), in the group of the freshly expanded plastics particles with progressing time.

However, the expression “blowing agent reduction” is intended here also to comprise the other changes in the expanded plastics particles occurring on relatively long storage of the expanded plastics particles, for example shrinkage or aging.

In a suitable process, the expanded plastics particles are further used continuously for the production of the lignocellulose-containing substance. This means that the foaming of the expandable plastics particles and the further use thereof, preferably transportation into the plant for the production of the lignocellulose-containing substance, takes place in a process chain virtually uninterrupted over a period of time.

During the transport of the expandable plastics particles into the plant for the production of the lignocellulose-containing substance, the transport path for the expanded plastics particles may have one or more buffer containers connected in series or in parallel.

The plant for the production of the lignocellulose-containing substance also comprises, as a rule, a mixing apparatus in which the component B) is mixed with the other components.

In a preferred embodiment, the above-described expansion (“foaming”) of the expandable plastics particles is carried out at the site of the production of the lignocellulose-containing, preferably wood-containing, substance and the expanded plastics particles thus obtained are directly further used, for example without further measures for blowing agent reduction, for example directly fed into the apparatus for production of the lignocellulose-containing substance, preferably wood-containing substance.

Here, “at the site” means close to, for example in the radius of about 200 meters or in the vicinity of the apparatus in which the wood-containing substance is produced and, if appropriate, further processed.

In a further preferred embodiment, the above-described expansion (“foaming”) of the expandable plastics particles is carried out at the site of the production of the lignocellulose-containing, preferably wood-containing, substance in a mobile foaming apparatus and the expanded plastics particles thus obtained are directly further used, for example without further measures for blowing agent reduction, for example directly fed into the apparatus for the production of the lignocellulose-containing substance, preferably wood-containing substance.

Here, “at the site” means close to, for example in a radius of about 200 meters, or in the vicinity of the apparatus in which the wood-containing substance is produced and, if appropriate, further processed.

Here, “mobile foaming apparatus” means that the foaming apparatus can be easily assembled and dismantled or is, preferably, mobile, for example is mounted on a wheeled vehicle (for example a truck) or railway vehicle. Mobile foaming apparatuses as a truck superstructure are described, for example, by HIRSCH Servo AG, Glanegg 58, A-9555 Glanegg.

Suitable polymers on which the expandable or expanded plastics particles are based are all polymers, preferably thermoplastic polymers, which can be foamed. These are known to the person skilled in the art.

Suitable such polymers are, for example, polyketones, polysulfones, polymethylene, PVC (rigid and flexible), polycarbonates, polyisocyanurates, polycarbodiimides, polyacrylimides and polymethacrylimides, polyamides, polyurethanes, aminoplast resins and phenol resins, styrene homopolymers (also referred to below as “polystyrene” or “styrene polymer”), styrene copolymers, C₂-C₁₀-olefin homopolymers, C₂-C₁₀-olefin copolymers and polyesters.

The 1-alkenes, for example ethylene, propylene, 1-butene, 1-hexene, 1-octene, are preferably used for the preparation of said olefin polymers.

The expanded plastics particles of component B) have a bulk density of from 10 to 100 kg/m³, preferably from 45 to 100 kg/m³, particularly preferably from 45 to 80 kg/m³, in particular from 50 to 70 kg/m³. The bulk density is usually determined by weighing a defined volume filled with the bulk material.

Expanded plastics particles B) are generally used in the form of spheres or beads having an average diameter of, advantageously, from 0.25 to 10 mm, preferably from 0.4 to 8.5 mm, in particular from 0.4 to 7 mm.

Expanded particulate plastics spheres B) advantageously have a small surface area per unit volume, for example in the form of a spherical or elliptical particle.

The expanded particulate plastics spheres B) advantageously have closed cells. The proportion of open cells according to DIN-ISO 4590 is as a rule less than 30%.

If the component B) consists of different polymer types, i.e. polymer types which are based on different monomers (for example polystyrene and polyethylene or polystyrene and homopolypropylene or polyethylene and homopolypropylene), these may be present in different weight ratios which, however, according to the current state of knowledge, are not critical.

Furthermore, additives, for example UV stabilizers, antioxidants, coating materials, water repellents, nucleating agents, plasticizers, flameproofing agents, soluble and insoluble inorganic and/or organic dyes, pigments and athermanous particles, such as carbon black, graphite or aluminum powder, can be added, together or spatially separately, as additives to the polymers, preferably the thermoplastics, on which the expandable or expanded plastics particles B) are based.

All blowing agents known to the person skilled in the art, for example aliphatic C₃- to C₁₀-hydrocarbons, such as propane, n-butane, isobutane, n-pentane, isopentane, neopentane, cyclopentane and/or hexane, and isomers thereof, alcohols, ketones, esters, ethers or halogenated hydrocarbons, can be used for expanding the expandable plastics particles.

The content of blowing agent in the expandable plastics particles is in the range from 0.01 to 7% by weight, preferably from 0.01 to 4% by weight, particularly preferably from 0.1 to 4% by weight, based in each case on the expandable plastics particles containing blowing agent.

Styrene homopolymer (also referred to herein simply as “polystyrene”) and/or styrene copolymer are preferably used as the sole plastics particle component in component B).

Such polystyrene and/or styrene copolymer can be prepared by all polymerization processes known to the person skilled in the art, cf. for example Ullmann's Encyclopedia, Sixth Edition, 2000 Electronic Release, or Kunststoff-Handbuch 1996, volume 4 “Polystyrol”, pages 567 to 598.

The preparation of the expandable polystyrene and/or styrene copolymer is effected as a rule in a manner known per se by suspension polymerization or by means of extrusion processes.

In the suspension polymerization, styrene, if appropriate with addition of further comonomers, is polymerized in aqueous suspension in the presence of a customary suspension stabilizer by means of catalysts forming free radicals. The blowing agent and, if appropriate, further additives can be concomitantly initially taken in the polymerization or added to the batch in the course of the polymerization or after the end of the polymerization. The bead-like, expandable styrene polymers obtained, which are impregnated with blowing agent, are separated from the aqueous phase after the end of polymerization, washed, dried and screened.

In the extrusion process, the blowing agent is mixed into the polymer for example via an extruder, transported through a die plate and granulated under pressure to give particles or strands.

All blowing agents known to the person skilled in the art and already mentioned above are used as blowing agents for the preparation of the expandable polystyrene and/or styrene copolymer, for example aliphatic C₃- to C₁₀-hydrocarbons, such as propane, n-butane, isobutane, n-pentane, isopentane, neopentane, cyclopentane and/or hexane and isomers thereof, alcohols, ketones, esters, ethers or halogenated hydrocarbons.

The blowing agent is preferably selected from the group consisting of n-pentane, isopentane, neopentane and cyclopentane. A commercially available pentane isomer mixture comprising n-pentane and isopentane is particularly preferably used.

The content of blowing agent in the expandable polystyrene or styrene copolymer is in the range from 0.01 to 7% by weight, preferably from 0.01 to 4% by weight, more preferably from 0.1 to 4% by weight, particularly preferably from 0.5 to 3.5% by weight, based in each case on the expandable polystyrene or styrene copolymer containing blowing agent.

The content of C₃- to C₁₀-hydrocarbons as blowing agent in the expandable polystyrene or styrene copolymer is in the range from 0.01 to 7% by weight, preferably from 0.01 to 4% by weight, more preferably from 0.1 to 4% by weight, particularly preferably from 0.5 to 3.5% by weight, based in each case on the expandable polystyrene or styrene copolymer containing blowing agent.

The content of blowing agent selected from the group consisting of n-pentane, isopentane, neopentane and cyclopentane in the expandable polystyrene or styrene copolymer is in the range from 0.01 to 7% by weight, preferably from 0.01 to 4% by weight, more preferably from 0.1 to 4% by weight, particularly preferably from 0.5 to 3.5% by weight, based in each case on the expandable polystyrene or styrene copolymer containing blowing agent.

The content of blowing agent selected from the group consisting of n-pentane, isopentane, neopentane and cyclopentane in the expandable polystyrene is in the range from 0.01 to 7% by weight, preferably from 0.01 to 4% by weight, more preferably from 0.1 to 4% by weight, particularly preferably from 0.5 to 3.5% by weight, based in each case on the expandable polystyrene containing blowing agent.

The above-described preferred or particularly preferred expandable styrene polymers or expandable styrene copolymers have a relatively low content of blowing agent. Such polymers are also referred to as “low in blowing agent”. A suitable process for preparation of expandable polystyrene or expandable styrene copolymer low in blowing agent is described in U.S. Pat. No. 5,112,875, which is hereby incorporated by reference.

Furthermore, additives, for example UV stabilizers, antioxidants, coating materials, water repellents, nucleating agents, plasticizers, flameproofing agents, soluble and insoluble inorganic and/or organic dyes, pigments and athermanous particles, such as carbon black, graphite or aluminum powder, can be added, together or spatially separately, as additives to the styrene polymers or styrene copolymers.

As described, styrene copolymers can also be used. Advantageously, these styrene copolymers have at least 50% by weight, preferably at least 80% by weight, of styrene incorporated in the form of polymerized units. Suitable comonomers are, for example, α-methylstyrene, styrenes halogenated on the nucleus, acrylonitrile, esters of acrylic or methacrylic acid with alcohols having 1 to 8 carbon atoms, N-vinylcarbazole, maleic acid(anhydride), (meth)acrylamides and/or vinyl acetate.

Advantageously, the polystyrene and/or styrene copolymer may comprise a small amount of a chain-branching agent incorporated in the form of polymerized units, i.e. of a compound having more than one double bond, preferably two double bonds, such as divinylbenzene, butadiene and/or butanediol diacrylate. The branching agent is generally used in amounts of from 0.0005 to 0.5 mol %, based on styrene.

Preferably, styrene polymers or styrene copolymers having a molecular weight in the range from 70 000 to 400 000 g/mol, particularly preferably from 190 000 to 400 000 g/mol, very particularly preferably from 210 000 to 400 000 g/mol, are used.

Mixtures of different styrene (co)polymers may also be used.

Suitable styrene homopolymers or styrene copolymers are crystal-clear polystyrene (GPPS), high impact polystyrene (HIPS), anionically polymerized polystyrene or impact-resistant polystyrene (A-IPS), styrene-α-methylstyrene copolymers, acrylonitrile-butadiene-styrene polymers (ABS), styrene-acrylonitrile (SAN), acrylonitrile-styrene-acrylate (ASA), methyl acrylate-butadiene-styrene (MBS), methyl methacrylate-acrylonitrile-butadiene-styrene (MABS) polymers or mixtures thereof or with polyphenylene ether (PPE).

Particularly preferably, a styrene homopolymer having a molecular weight in the range from 70 000 to 400 000 g/mol, particularly preferably from 190 000 to 400 000 g/mol, very particularly preferably from 210 000 to 400 000 g/mol, is used.

For the preparation of expanded polystyrene as component B) and/or expanded styrene copolymer as component B), in general the expandable styrene homopolymers or expandable styrene copolymers are expanded (often also referred to as “foamed”) in a known manner by heating to temperatures above their softening point, for example by hot air or preferably steam, and/or a pressure change, as described, for example, in Kunststoff Handbuch 1996, volume 4 “Polystyrol”, Hanser 1996, pages 640 to 673, or U.S. Pat. No. 5,112,875. The expandable polystyrene or expandable styrene copolymer is obtainable as a rule in a manner known per se by suspension polymerization or by means of extrusion processes as described above.

On expansion, the blowing agent expands, the polymer particles increase in size and cell structures form.

This expansion is generally carried out in customary foaming apparatuses, often referred to as “prefoamers”. Such prefoamers may be installed in a stationary manner or may be mobile.

The expansion can be carried out in one stage or a plurality of stages. As a rule, in the one-stage process, the expandable polystyrene particles or expandable styrene copolymer particles are expanded directly to the desired final size.

As a rule, in the multistage process, the polystyrene particles or expandable styrene copolymer particles are first expanded to an intermediate size and then expanded in one or more further stages via a corresponding number of intermediate sizes to the desired final size.

Preferably, the expansion is carried out in one stage.

The expandable polystyrene particles (styrene homopolymer particles) or expandable styrene copolymer particles comprise as a rule no cell structures, in contrast to the expanded polystyrene particles or expanded styrene copolymer particles.

The content of blowing agent in the expanded polystyrene or expanded styrene copolymer, preferably styrene homopolymer, is in the range from 0 to 5.5% by weight, preferably from 0 to 3% by weight, more preferably from 0 to 2.5% by weight, particularly preferably from 0 to 2% by weight, based in each case on the expanded polystyrene or expanded styrene copolymer.

Here, 0% by weight means that no blowing agent can be detected by the customary detection methods.

These expanded polystyrene particles or expanded styrene copolymer particles can be further used without or with further measures for blowing agent reduction for the production of the lignocellulose-containing substance.

The expanded polystyrene particles or expanded styrene copolymer particles thus obtained are preferably further used without further intermediate steps for the production of the lignocellulose-containing substance.

Customary measures for ensuring production, such as feeding the expanded polystyrene particles or expanded styrene copolymer particles into so-called buffer containers, which, for example, compensate for variations in the metering of the expanded polystyrene particles or expanded styrene copolymer particles, or temporary storage for blowing agent reduction of the expanded polystyrene particles or expanded styrene copolymer particles and the mixing of the expanded polystyrene particles or expanded styrene copolymer particles with other additives, for example components A), C) or, if appropriate, D), are not intermediate steps in the context of this invention.

Customary measures for blowing agent reduction of expanded polystyrene particles or expanded styrene copolymer particles are, for example, relatively long storage, in general for from one to several days, of the expanded polystyrene particles or expanded styrene copolymer particles in open vessels or in vessels having walls permeable to the blowing agent. This storage generally takes place at ambient temperature, for example from 20 to 30° C.

Here, “blowing agent reduction” is the reduction of blowing agent concentration in the group of freshly expanded polystyrene particles or expanded styrene copolymer particles with progressing time, detectable by customary analytical methods (for example gas chromatography).

Customary measures for blowing agent reduction of expanded polystyrene particles or expanded styrene copolymer particles are, for example, relatively long storage, in general for from 12 hours to several days, of the expanded polystyrene particles or expanded styrene copolymer particles in open vessels or in vessels having walls permeable to the blowing agent. This storage generally takes place at ambient temperature, for example, from 20 to 30° C.

Here, “blowing agent reduction” is the reduction of the blowing agent concentration, detectable by customary analytical methods (for example gas chromatography), and the group of freshly expanded polystyrene particles or freshly expanded styrene copolymer particles as time progresses. However, the expression “blowing agent reduction” is also intended here to comprise the other changes occurring, on relatively long storage of the expanded polystyrene particles or expanded styrene copolymer particles, in the expanded polystyrene particles or expanded styrene copolymer particles, for example shrinkage or aging.

Customary measures for blowing agent reductions can be avoided by the process according to the invention.

In a suitable process, the expanded polystyrene particles or expanded styrene copolymer particles are further used continuously for the production of the lignocellulose-containing substance. This means that the foaming of the expanded polystyrene particles or expanded styrene copolymer particles and the further use thereof, preferably transport into the plant for the production of the lignocellulose-containing substance, take place in a process chain virtually uninterrupted over a period of time. The plant for the production of the lignocellulose-containing substance also comprises, as a rule, a mixing apparatus in which the component B) is mixed with the other components.

In a preferred embodiment, the above-described expansion (“foaming”) of the expandable polystyrene particles or expandable styrene copolymer particles is carried out at the site of the production of the lignocellulose-containing, preferably wood-containing, substance and the expanded polystyrene particles or expanded styrene copolymer particles thus obtained are further used without further measures for blowing agent reduction, for example fed directly into the apparatus for the production of the lignocellulose-containing substance, preferably wood-containing substance. Here, “at the site” means close to, for example in a radius of about 200 meters, or in the vicinity of the apparatus in which the wood-containing substance is produced and, if appropriate, further processed.

In a further preferred embodiment, the above-described expansion (“foaming”) of the expandable polystyrene particles or expandable styrene copolymer particles is carried out at the site of the production of the lignocellulose-containing, preferably wood-containing, substance in a mobile foaming apparatus and the expanded polystyrene particles or expanded styrene copolymer particles thus obtained are further used without further measures for blowing agent reduction, for example fed directly into the apparatus for the production of the lignocellulose-containing substance, preferably wood-containing substance. Here, “at the site” means close to, for example in a radius of about 200 meters, or in the vicinity of the apparatus in which the wood-containing substance is produced and, if appropriate, further processed.

Here, “mobile foaming apparatus” means that the foaming apparatus can be easily assembled and dismantled or, preferably, is mobile, for example mounted on a wheeled vehicle (for example a truck) or railway vehicle. Mobile foaming apparatuses as a truck superstructure are described, for example, by HIRSCH Servo AG, Glanegg 58, A-9555 Glanegg.

The expanded polystyrene or expanded styrene copolymer advantageously has a bulk density of from 10 to 100 kg/m³, preferably from 45 to 100 kg/m³, particularly preferably from 45 to 80 kg/m³, in particular from 50 to 70 kg/m³.

The expanded polystyrene or expanded styrene copolymer is advantageously used in the form of spheres or beads having a mean diameter in the range from 0.25 to 10 mm, preferably in the range from 1 to 8.5 mm, in particular in the range from 1.2 to 7 mm.

The expanded polystyrene or expanded styrene copolymer spheres advantageously have a small surface area per unit volume, for example in the form of a spherical or elliptical particle.

The expanded polystyrene or expanded styrene copolymer spheres advantageously have closed cells. The proportion of open cells according to DIN-ISO 4590 is as a rule less than 30%.

Usually, the expandable polystyrene or expandable styrene copolymer or the expanded polystyrene or expanded styrene copolymer has an antistatic coating.

Substances usual and customary in industry can be used as antistatic agents. Examples are N,N-bis(2-hydroxyethyl)-C₁₂-C₁₈-alkylamines, fatty acid diethanolamides, choline ester chlorides of fatty acids, C₁₂-C₂₀-alkylsulfonates, ammonium salts.

Suitable ammonium salts comprise, on the nitrogen, in addition to alkyl groups, from 1 to 3 organic radicals containing hydroxyl groups.

Suitable quaternary ammonium salts are, for example, those which comprise from 1 to 3, preferably 2, identical or different alkyl radicals having 1 to 12, preferably 1 to 10, carbon atoms and 1 to 3, preferably 2, identical or different hydroxyalkyl or hydroxyalkylpolyoxyalkylene radicals bonded to the nitrogen cation, with any desired anion, such as chloride, bromide, acetate, methylsulfate or p-toluenesulfonate.

The hydroxyalkyl and hydroxyalkylpolyoxyalkylene radicals are those which form as a result of oxyalkylation of a nitrogen-bonded hydrogen atom and are derived from 1 to 10 oxyalkylene radicals, in particular oxyethylene and oxypropylene radicals.

A quaternary ammonium salt or an alkali metal salt, in particular sodium salt, of a C₁₂-C₂₀ alkanesulfonate or a mixture thereof is particularly preferably used as an antistatic agent. The antistatic agents can be added as a rule both as pure substance and in the form of an aqueous solution.

In the process for the preparation of polystyrene or styrene copolymer, the antistatic agent can be added in an analogous manner to the customary additives or can be applied as a coating after the production of the polystyrene particles.

The antistatic agent is advantageously used in an amount of from 0.05 to 6% by weight, preferably from 0.1 to 4% by weight, based on the polystyrene or styrene copolymer.

The expanded plastics particles B) are generally present in a virtually unmelted state even after the pressing to give the lignocellulose material, preferably wood-base material, preferably multilayer lignocellulose material, particularly preferably multilayer wood-base material. That means that the plastics particles B) have generally not penetrated into the lignocellulose particles or impregnated the latter, but rather are distributed between the lignocellulose particles. Usually, the plastics particles B) can be separated from the lignocellulose using physical methods, for example after the comminution of the lignocellulose material.

The total amount of the expanded plastics particles B), based on the lignocellulose-containing, preferably wood-containing, substance is in the range from 1 to 25% by weight, preferably 3 to 20% by weight, particularly preferably 5 to 15% by weight.

The total amount of the expanded plastics particles B) with polystyrene and/or styrene copolymer as the sole particulate plastics component, based on the lignocellulose-containing, preferably wood-containing, substance, is in the range from 1 to 25% by weight, preferably 3 to 20% by weight, particularly preferably 5 to 15% by weight.

The matching of the dimensions of the expanded plastics particles B) described above to the lignocellulose particles, preferably wood particles A), or vice versa, has proven advantageous.

This matching is expressed below by the relationship of the respective d′ values (from the Rosin-Rammler-Sperling-Bennet function) of the lignocellulose particles, preferably wood particles A), and of the expanded plastics particles B).

The Rosin-Rammler-Sperling-Bennet function is described, for example, in DIN 66145.

For determining the d′ values, sieve analyses are first carried out for determining the particle size distribution of the expanded plastics particles B) and lignocellulose particles, preferably wood particles A), analogously to DIN 66165, parts 1 and 2.

The values from the sieve analysis are then inserted into the Rosin-Rammler-Sperling-Bennet function and d′ is calculated.

The Rosin-Rammler-Sperling-Bennet function is:

R=100*exp(−(d/d)ⁿ))

with the following meanings of the parameters:
R residue (% by weight) which remains on the respective sieve tray
d particle size
d′ particle size at 36.8% by weight of residue
n width of the particle size distribution

Suitable lignocellulose particles, preferably wood particles A), have a d′ value, according to Rosin-Rammler-Sperling-Bennet (definition and determination of the d′ value as described above), in the range from 0.1 to 5.0, preferably in the range from 0.3 to 3.0 and particularly preferably in the range from 0.5 to 2.75.

Suitable lignocellulose-containing, preferably wood-containing, substances or multilayer lignocellulose materials, preferably multilayer wood-base materials, are obtained if the following relationship is true for the d′ values, according to Rosin-Rammler-Sperling-Bennet, of the lignocellulose particles, preferably wood particles A), and the particles of the expanded plastics particles B):
d′ of the particles A)≦2.5×d′ of the particles B), preferably
d′ of the particles A)≦2.0×d′ of the particles B), particularly preferably
d′ of the particles A)≦1.5×d′ of the particles B), very particularly preferably
d′ of the particles A)≦d′ of the particles B).

The binder C) is selected from the group consisting of aminoplast resin, phenol-formaldehyde resin and organic isocyanate having at least two isocyanate groups. In the present application, the absolute and percentage quantity data with respect to the component C) are based on these components.

The binder C) comprises, as a rule, the substances known to the person skilled in the art, generally used for aminoplasts or phenol-formaldehyde resins and usually referred to as curing agents, such as ammonium sulfate or ammonium nitrate or inorganic or organic acids, for example sulfuric acid, formic acid, or acid-regenerating substances, such as aluminum chloride, aluminum sulfate, in each case in the customary, small amounts, for example in the range from 0.1% by weight to 3% by weight, based on the total amount of aminoplast resin in the binder C).

Phenol-formaldehyde resins (also referred to as PF resins) are known to the person skilled in the art, cf. for example Kunststoff-Handbuch, 2nd edition, Hanser 1988, volume 10 “Duroplaste”, pages 12 to 40.

Here, aminoplast resin is understood as meaning polycondensates of compounds having at least one carbamide group optionally partly substituted by organic radicals (the carbamide group is also referred to as carboxamide group) and an aldehyde, preferably formaldehyde.

All aminoplast resins known to the person skilled in the art, preferably those known for the production of wood-base materials, can be used as suitable aminoplast resin. Such resins and their preparation are described, for example, in Ullmanns Enzyklopädie der technischen Chemie, 4th newly revised and extended edition, Verlag Chemie, 1973, pages 403 to 424 “Aminoplaste”, and Ullmann's Encyclopedia of Industrial Chemistry, Vol. A2, VCH Verlagsgesellschaft, 1985, pages 115 to 141 “Amino Resins”, and in M. Dunky, P. Niemz, Holzwerkstoffe and Leime, Springer 2002, pages 251 to 259 (UF resins) and pages 303 to 313 (MUF and UF with a small amount of melamine).

Preferred aminoplast resins are polycondensates of compounds having at least one carbamide group, also partly substituted by organic radicals, and formaldehyde.

Particularly preferred aminoplast resins are urea-formaldehyde resins (UF resins), melamine-formaldehyde resins (MF resins) or melamine-containing urea-formaldehyde resins (MUF resins).

Very particularly preferred aminoplast resins are urea-formaldehyde resins, for example Kaurit® glue types from BASF Aktiengesellschaft.

Further very preferred aminoplast resins are polycondensates of compounds having at least one amino group, also partly substituted by organic radicals, and aldehyde, in which the molar ratio of aldehyde to amino group optionally partly substituted by organic radicals is in the range from 0.3 to 1.0, preferably from 0.3 to 0.60, particularly preferably from 0.3 to 0.45, very particularly preferably from 0.30 to 0.40.

Further very preferred aminoplast resins are polycondensates of compounds having at least one amino group —NH₂ and formaldehyde, in which the molar ratio of formaldehyde to —NH₂ group is in the range from 0.3 to 1.0, preferably from 0.3 to 0.60, particularly preferably from 0.3 to 0.45, very particularly preferably from 0.30 to 0.40.

Further very preferred aminoplast resins are urea-formaldehyde resins (UF resins), melamine-formaldehyde resins (MF resins) or melamine-containing urea-formaldehyde resins (MUF resins), in which the molar ratio of formaldehyde to —NH₂ group is in the range from 0.3 to 1.0, preferably from 0.3 to 0.60, particularly preferably from 0.3 to 0.45, very particularly preferably from 0.30 to 0.40.

Further very preferred aminoplast resins are urea-formaldehyde resins (UF resins) in which the molar ratio of formaldehyde to —NH₂ group is in the range from 0.3 to 1.0, preferably from 0.3 to 0.60, particularly preferably from 0.3 to 0.45, very particularly preferably from 0.30 to 0.40.

Said aminoplast resins are usually used in liquid form, generally suspended in a liquid suspending medium, preferably in aqueous suspension, but can also be used as a solid.

The solids content of the aminoplast resin suspensions, preferably aqueous suspension, is usually from 25 to 90% by weight, preferably from 50 to 70% by weight.

The solids content of the aminoplast resin in aqueous suspension can be determined according to Günter Zeppenfeld, Dirk Grunwald, Klebstoffe in der Holz- und Möbelindustrie, 2nd edition, DRW-Verlag, page 268. For determining the solids content of aminoplast glues, 1 g of aminoplast glue is accurately weighed into a weighing dish, finely distributed over the bottom and dried for 2 hours at 120° C. in a drying oven. After cooling to room temperature in a desiccator, the residue is weighed and is calculated as a percentage of the weight taken.

The aminoplast resins are prepared by known processes (cf. abovementioned Ullmann literature “Aminoplaste” and “Amino Resins”, and abovementioned literature Dunky et al.) by reacting the compounds containing carbamide groups, preferably urea and/or melamine, with the aldehydes, preferably formaldehyde, in the desired molar ratios of carbamide group to aldehyde, preferably in water as a solvent.

The desired molar ratio of aldehyde, preferably formaldehyde, to amino group optionally partly substituted by organic radicals can also be established by addition of monomers carrying —NH₂ groups to formaldehyde-richer prepared, preferably commercial, aminoplast resins. Monomers carrying NH₂ groups are preferably urea or melamine, particularly preferably urea.

The further component of the binder C) may be an organic isocyanate having at least two isocyanate groups.

All organic isocyanates known to the person skilled in the art, preferably those known for the production of wood-base materials or polyurethanes, can be used as a suitable organic isocyanate. Such organic isocyanates and their preparation and use are described, for example, in Becker/Braun, Kunststoff Handbuch, 3rd newly revised edition, volume 7 “Polyurethane”, Hanser 1993, pages 17 to 21, pages 76 to 88 and pages 665 to 671.

Preferred organic isocyanates are oligomeric isocyanates having 2 to 10, preferably 2 to 8, monomer units and on average at least one isocyanate group per monomer unit.

A particularly preferred organic isocyanate is the oligomeric organic isocyanate PMDI (“polymeric methylenediphenylene diisocyanate”), which is obtainable by condensation of formaldehyde with aniline and phosgenation of the isomers and oligomers formed in the condensation (cf. for example Becker/Braun, Kunststoff Handbuch, 3rd newly revised edition, volume 7 “Polyurethane”, Hanser 1993, page 18, last paragraph to page 19, second paragraph, and page 76, fifth paragraph).

PMDI products which are very suitable in the context of the present invention are the products of the LUPRANAT® series from BASF Aktiengesellschaft, in particular LUPRANAT® M 20 FB from BASF Aktiengesellschaft.

It is also possible to use mixtures of the organic isocyanates described, the mixing ratio not being critical according to the current state of knowledge.

The resin constituents of the binder C) can be used by themselves, i.e. for example aminoplast resin as the sole resin constituent of the binder C), or organic isocyanate as the sole resin constituent of the binder C) or PF resin as the sole constituent of the binder C).

The resin constituents of the binder C) can, however, also be used as a combination of two or more resin constituents of the binder C).

The total amount of the binder C), based on the wood-containing substance, is in the range from 3 to 50% by weight, preferably from 5 to 15% by weight, particularly preferably from 7 to 10% by weight.

Here, the total amount of the aminoplast resin (always based on the solid), preferably the urea-formaldehyde resin and/or melamine-urea-formaldehyde resin and/or melamine-formaldehyde resin, particularly preferably urea-formaldehyde resin, in the binder C), based on the lignocellulose-containing, preferably wood-containing, substance, is in the range from 1 to 45% by weight, preferably 4 to 14% by weight, particularly preferably 6 to 9% by weight.

Here, the total amount of the organic isocyanate, preferably of the oligomeric isocyanate having 2 to 10, preferably 2 to 8, monomer units and an average of at least one isocyanate group per monomer unit, particularly preferably PMDI, in the binder C), based on the lignocellulose-containing, preferably wood-containing, substance is in the range from 0 to 5% by weight, preferably from 0.1 to 3.5% by weight, particularly preferably from 0.5 to 1.5% by weight.

The ratios of the aminoplast resin to the organic isocyanate arise from the above-described ratios of the aminoplast resin binder to lignocellulose-containing, preferably wood-containing, substance or of the organic isocyanate binder to lignocellulose-containing, preferably wood-containing, substance.

Preferred embodiments of the wood-containing substance comprise from 55 to 92.5% by weight, preferably from 60 to 90% by weight, in particular from 70 to 88% by weight, based on the wood-containing substance, of wood particles, the wood particles having an average density of from 0.4 to 0.85 g/cm³, preferably from 0.4 to 0.75 g/cm³, in particular from 0.4 to 0.6 g/cm³, from 1 to 25% by weight, preferably from 3 to 20% by weight, in particular from 5 to 15% by weight, based on the wood-containing substance, of polystyrene and/or styrene copolymer as component B) having a bulk density of from 10 to 100 kg/m³, preferably from 20 to 80 kg/m³, in particular from 30 to 60 kg/m³, and from 3 to 40% by weight, preferably from 5 to 25% by weight, in particular from 5 to 15% by weight, based on the wood-containing substance, of binder, the total amount of the aminoplast resin, preferably of the urea-formaldehyde resin and/or melamine-urea-formaldehyde resin and/or melamine-formaldehyde resin, particularly preferably urea-formaldehyde resin, in the binder C), based on the wood-containing substance, being in the range from 1 to 45% by weight, preferably 4 to 14% by weight, particularly preferably 6 to 9% by weight, and the average density of the wood-containing substance being in the range from more than 600 to 900 kg/m³, preferably in the range from more than 600 to 850 kg/m³.

If appropriate, further commercially available additives known to the person skilled in the art may be present as component D) in the lignocellulose-containing, preferably wood-containing, substance according to the invention or the multilayer lignocellulose material, preferably multilayer wood-base material, according to the invention, for example water repellents, such as paraffin emulsions, antifungal agents, formaldehyde scavengers, for example urea or polyamines, and flameproofing agents.

The present invention furthermore relates to a process for the production of a multilayer lignocellulose material which comprises at least three layers, either only the middle layer or at least some of the middle layers comprising a lignocellulose-containing substance as defined above or, apart from the middle layer or at least some of the middle layers, at least one further layer comprising a lignocellulose-containing substance as defined above, the components for the individual layers being placed in layers one on top of the other and pressed at elevated temperature and elevated pressure.

The average density of multilayer lignocellulose material according to the invention, preferably of the three-layer lignocellulose material according to the invention, preferably wood-base material, is in the range from more than 600 kg/m³ to 900 kg/m³, preferably in the range from more than 600 kg/m³ to 850 kg/m³, particularly preferably in the range from more than 600 kg/m³ to 800 kg/m³.

Preferred parameter ranges and preferred embodiments with regard to the average density of the lignocellulose-containing, preferably wood-containing, substance and with regard to the components and the preparation processes A), B), C) and D) thereof and the combination of the features correspond to the above description.

In a suitable process, the expanded polystyrene particles or expanded styrene copolymer particles are further used continuously for the production of the lignocellulose-containing substance and of the multilayer lignocellulose material. This means that the foaming of the expanded polystyrene particles or expanded styrene copolymer particles and the further use thereof, preferably transport into the plant for the production of the lignocellulose-containing substance and/or multilayer lignocellulose material, takes place in a process chain virtually uninterrupted over a period of time.

In a preferred embodiment for the production of a multilayer lignocellulose material, the expandable plastics particles, as described in more detail above, are foamed at the site of the production of the lignocellulose-containing substance to give expanded plastics particles.

In a further preferred embodiment for the production of a multilayer lignocellulose material, the expandable plastics particles, as described in more detail above, are foamed at the site of the production of the lignocellulose-containing substance in a mobile foaming apparatus to give expanded plastics particles.

Middle layers in the context of the invention are all layers which are not the outer layers.

In one embodiment, at least one of the outer layers (usually referred to as “covering layer(s)”) comprises expanded plastics particles B).

In a further embodiment, at least one of the outer layers (usually referred to as “covering layer(s)”) comprises no expanded plastics particles B).

In a preferred embodiment, the outer layers (usually referred to as “covering layer(s)”) comprise no expanded plastics particles B).

Preferably, the multilayer lignocellulose material, preferably multilayer wood-base material, according to the invention comprises three lignocellulose layers, preferably layers of pulp material, the outer covering layers together being as a rule thinner than the inner layer(s).

The binder used for the outer layers is usually an aminoplast resin, for example urea-formaldehyde resin (UF), melamine-formaldehyde resin (MF), melamine-urea-formaldehyde resin (MUF) or the binder C) according to the invention. The binder used for the outer layers is preferably an aminoplast resin, particularly preferably a urea-formaldehyde resin, very particularly preferably an aminoplast resin in which the molar ratio of formaldehyde to —NH₂ groups is in the range from 0.3 to 1.0.

The thickness of the multilayer lignocellulose material, preferably multilayer wood-base material, according to the invention varies with the field of use and is as a rule in the range from 0.5 to 100 mm, preferably in the range from 10 to 40 mm, in particular from 15 to 20 mm.

The processes for the production of multilayer wood-base materials are known in principle and are described, for example, in M. Dunky, P. Niemz, Holzwerkstoffe and Leime, Springer 2002, pages 91 to 150.

An example of a process for the production of a multilayer wood-base material according to the invention is described below.

After chipping of the wood, the chips are dried. If appropriate, coarse and fine fractions are then removed. The remaining chips are sorted by screening or classification in an air stream. The coarser material is used for the middle layer and the finer material for the covering layers.

Middle layer and covering layer chips are glue-coated or mixed separately from one another in each case with the components B) (only the middle layer(s) or else middle layer(s) and at least one covering layer), C) (identical or different for middle layer(s) and covering layer(s)) and, if appropriate, D) (middle layer and/or covering layers), and then sprinkled.

The component B) is obtained by expansion of the expandable plastics particles and mixed directly or after temporary storage and preferably continuously with the other components for the production of the middle layer.

First, the covering layer material is sprinkled onto the shaping belt, then the middle layer material—comprising the components B), C) and, if appropriate, D)—and finally once again covering layer material. The three-layer chip cake thus produced is precompacted while cold (as a rule at room temperature) and then hot-pressed.

The pressing can be effected by all methods known to the person skilled in the art. Usually, the wood particle cake is pressed at a press temperature of from 150° C. to 230° C. to the desired thickness. The duration of pressing is usually from 3 to 15 seconds per mm board thickness. A three-layer particle board is obtained.

### EXAMPLES

### A) Preparation of the Expanded Polystyrene

Neopor® 2400 (Neopor® is a trade product and brand of BASF SE) was treated with steam in a continuous preexpander. The bulk density of 50 kg/m³ of the preexpanded polystyrene beads is adjusted by varying the vapor pressure and the steam-treatment time.

### B) Production of a Multilayer Wood-Base Material with and without Component B) Using Urea-Formaldehyde Glues

### B1) Glue Liquor for the Corresponding Steps

The glue used was Kaurit® glue KL 347 from BASF SE, a UF resin. The glue was mixed with further components (see table below) to give a glue liquor. The compositions of the aqueous glue liquors for the covering layer and the middle layer are shown in the table below.

TABLE 1
Glue liquors for covering layer and middle layer

| | Covering layer | Middle layer |
|---|---|---|
| Components | (parts by weight) | (parts by weight) |
| KML 347 liquid | 100.0 | 100.0 |
| Ammonium nitrate solution | 1.0 | 4.0 |
| (52% strength) | | |
| Urea, solid | 0.5 | 1.3 |
| Water | 0.5 | 0.8 |

### B2) Production of the Three-Layer Wood-Base Materials According to the Invention

The glue application and the pressing of the woodchips take place analogously to customary processes for the production of particle boards.

### B2.1) Glue Application to the Middle Layer Material

Coarse spruce chips, optionally expanded polystyrene (prepared according to example A) above) were mixed with the glue liquor for the middle layer (according to table 1 above) in a mixer so that the amount of glue (as solid) was 8.5% by weight, based on absolutely dry wood plus expanded polystyrene.

The amount of the expanded polystyrene is based on the total amount of absolutely dry wood plus expanded polystyrene and is shown in table 2.

### B2.2) Glue Application to the Covering Layer Material

Fine spruce chips were mixed with glue liquor for the middle layer (according to table 1 above) in a mixer so that the amount of glue (as solid) was 8.5% by weight, based on absolutely dry wood.

### B 2.3) Pressing of the Glue-Coated Chips

The material for the production of a three-layer particle board was sprinkled into a 30×30 cm mold. First the covering layer material, then the middle layer material and finally once again the covering layer material was sprinkled. The total mass was chosen so that, at the end of the pressing process, the desired density resulted at a required thickness of 16 mm. The mass ratio (weight ratio) covering layer material:middle layer material:covering layer material was 17:66:17 in all experiments. The covering layer material used was the mixture described above under B2.2). The middle layer material used was the mixture described above under B2.1).

After the sprinkling, precompression was effected at room temperature, i.e. “cold”, and then pressing was effected in a hot press (pressing temperature 210° C., pressing time 210 s). The required thickness of the board was 16 mm in each case.

### C) Investigation of the Wood-Containing Substance

### C 1) Density

The density was determined 24 hours after production according to DIN EN 1058.

### C 2) Transverse Tensile Strength

The transverse tensile strength was determined according to DIN EN 319.

### C 3) Swelling Values and Water Absorption

The swelling values and the water absorption were determined according to DIN EN 317.

The results of the experiments are listed in table 2.

The stated amounts are always based on the dry substance. When stating the parts by weight, the dry wood or the sum of the dry wood and the filler is set at 100 parts. When stating the % by weight, the sum of all dry constituents of the wood-containing substance is equal to 100%.

The experiments in the table without addition of component B) serve for comparison.

TABLE 2
Experimental results

| | | | Three-layer |
|---|---|---|---|
| | Three-layer | Three-layer | wood-base |
| | wood-base | wood-base | material |
| | material | material | without |
| | according to | according to | addition of |
| | the invention | the invention | component B) |
| Additives in middle | 15% by | 10% by | None |
| layer (“ML”) | weight of | weight of | |
| | component B) | component B) | |
| | according to | according to | |
| | example A | example A | |
| Density, kg/m³ | 635 | 639 | 630 |
| Transverse tensile | 1.24 | 1.05 | 0.58 |
| strength, N/mm² | | | |
| Water absorption after | 64.6 | 70.2 | 101.6 |
| 24 h, % by weight | | | |
| Swelling after 24 h, | 14.3 | 18.2 | 24.4 |
| % by weight | | | |

1-11. (canceled)

12. A process for the production of a lignocellulose-containing substance having an average density in the range from more than 600 to 900 kg/m³, in which, in each case based on the lignocellulose-containing substance comprising
A) from 30 to 95% by weight of lignocellulose particles;
B) from 1 to 25% by weight of expanded plastics particles having a bulk density in the range from 10 to 100 kg/m³;
C) from 3 to 50% by weight of a binder selected from the group consisting of aminoplast resin, phenol-formaldehyde resin and organic isocyanate having at least two isocyanate groups and, optionally,
D) additives,
and the process comprises mixing and then pressing components A), B) C) and optionally D) at elevated temperature and under elevated pressure.

13. The process according to claim 12, the lignocellulose-containing particles being wood particles.

14. The process according to claim 12, the component B) being selected from the group consisting of styrene homopolymer and styrene copolymer.

15. The process according to claim 12, the bulk density of component B) being in the range from 45 to 100 kg/m³.

16. A process for the production of a multilayer lignocellulose material which comprises at least three layers, either only the middle layer or at least some of the middle layers comprising a lignocellulose-containing substance as produced according to claim 12, or, apart from the middle layer or at least some of the middle layers, a further layer comprising a light lignocellulose-containing substance produced according to claim 12, the components for the individual layers being placed in layers one on top of the other and pressed at elevated temperature and elevated pressure.

17. The process according to claim 16, at least one of the outer covering layers comprising expanded plastics particles B).

18. The process according to claim 12, at least one of the outer covering layers comprising no expanded plastics particles B).

19. A lignocellulose-containing substance, obtainable by the process as defined in claim 12.

20. A multilayer lignocellulose material, obtainable by the process as defined in claim 16.

21. A process for the production of an article which comprises the lignocellulose-containing substance as defined in claim 19.

22. A process for the production of an article which comprises the multilayer lignocellulose-containing substance as defined in claim 20.

23. The process as claimed in claim 21, wherein the article is in the construction center.

24. A process for the production of articles of furniture and furniture parts, of packaging materials, in house building or in interior finishing or in motor vehicles which comprises utilizing the lignocellulose-containing substance as defined in claim 19.

25. A process for the production of articles of furniture and furniture parts, of packaging materials, in house building or in interior finishing or in motor vehicles which comprises utilizing the multilayer lignocellulose-containing substance as defined in claim 20.
